(19) United States
(12) Patent Application Publication
(10) Pub. No.: US 2024/0190447 A1
(43) Pub. Date: Jun. 13, 2024

(54) DATA PROVISION SYSTEM, VEHICLE CONTROL SYSTEM, VEHICLE CONTROL DEVICE, AND STORAGE MEDIUM STORING DATA CONVERSION PROGRAM

(71) Applicant: DENSO CORPORATION, Kariya-city (JP)

(72) Inventors: Yasuaki KURITA, Kariya-city (JP); Hideyuki YAMAGUCHI, Kariya-city (JP); Satoshi NIWA, Kariya-city (JP); Hiroki KIMURA, Kariya-city (JP)

(21) Appl. No.: 18/581,146

(22) Filed: Feb. 19, 2024

Related U.S. Application Data
(63) Continuation of application No. PCT/JP22/32408, filed on Aug. 29, 2022.

(30) Foreign Application Priority Data
Aug. 27, 2021 (JP) 2021-139328

(51) Int. Cl. B60W 50/00; B60R 16/023

(52) U.S. Cl. CPC B60W 50/00; B60R 16/0231

(57) ABSTRACT

By a vehicle control system, a non-transitory computer readable storage medium storing a data conversion program, a data provision system, or a vehicle control device, data regarding a first vehicle control device is transmitted, the data transmitted from the first vehicle control device is acquired, the data acquired by the input unit is converted into standardization data in a predetermined format for each type of the data, semantic data obtained by semanticizing at least one piece of the standardization data is generated, and the second data based on the semantic data is transmitted to an application.

### CROSS REFERENCE TO RELATED APPLICATION

The present application is a continuation application of International Patent Application No. PCT/JP2022/032408 filed on Aug. 29, 2022 which designated the U.S. and claims the benefit of priority from Japanese Patent Application No. 2021-139328 filed on Aug. 27, 2021. The entire disclosures of the above application are incorporated herein by reference.

### TECHNICAL FIELD

The present disclosure relates to a data conversion program for converting data, a data provision system, a vehicle control system, and a vehicle control device.

### BACKGROUND

A technology for providing data from a vehicle side in response to a request from an application is known. For example, a related art discloses a configuration in which an application includes an adaptation section that exchanges data for each target element.

### SUMMARY

By a vehicle control system, a non-transitory computer readable storage medium storing a data conversion program, a data provision system, or a vehicle control device, data regarding a first vehicle control device is transmitted, the data transmitted from the first vehicle control device is acquired, the data acquired by the input unit is converted into standardization data in a predetermined format for each type of the data, semantic data obtained by semanticizing at least one piece of the standardization data is generated, and the second data based on the semantic data is transmitted to an application.

### BRIEF DESCRIPTION OF DRAWINGS

FIG. 1 is a block diagram illustrating a configuration of a data provision system.

FIG. 2 is a block diagram illustrating a configuration of an API section according to a first embodiment.

FIG. 3 is a block diagram illustrating a configuration of an API section according to a second embodiment.

FIG. 4 is a block diagram illustrating a configuration of an API section according to a third embodiment.

FIG. 5 is a block diagram illustrating a configuration of an API section according to another embodiment.

FIG. 6 is a block diagram illustrating a configuration of an API section according to still another embodiment.

FIG. 7 is a block diagram illustrating a configuration of an API section according to still another embodiment.

FIG. 8 is a block diagram illustrating a software configuration of an ECU.

FIG. 9 is a flowchart illustrating data storage processing.

FIG. 10 is a flowchart illustrating data transmission processing.

FIG. 11 is a block diagram illustrating a configuration of a data provision system according to still another embodiment.

### DETAILED DESCRIPTION

As a result of detailed studies by the inventors, in a configuration in which an application directly exchanges data with a vehicle control program for controlling a sensor or the like of a vehicle, it is necessary to develop an application for each vehicle in accordance with a specification of the vehicle control program, and there is a problem that addition and change of the application are complicated. Furthermore, the vehicle control program may be changed according to the application, but in this case, in a case where the application is frequently changed, there is a problem that the update of the vehicle control program cannot follow the life cycle of the application.

The present disclosure describes a configuration that can flexibly cope with addition or change of an application.

According to one aspect of the present disclosure, a vehicle control system comprises: a first vehicle control device that is configured to control a control target mounted on a vehicle; and a second vehicle control device that includes at least one processor and a memory coupled to the at least one processor and is communicably connected to the first vehicle control device. The first vehicle control device transmits data regarding the first vehicle control device. The second vehicle control device includes an input unit configured to acquire the data transmitted from the first vehicle control device, a calculation unit configured to convert the data acquired by the input unit into standardization data in a predetermined format for each type of the data, and generate semantic data obtained by semanticizing at least one piece of the standardization data, and an output unit configured to transmit second data based on the semantic data to an application. The data transmitted from the first vehicle control device is transmitted in one direction according to an order of the input unit, the calculation unit, and the output unit.

According to another aspect of the present disclosure, a non-transitory computer readable storage medium storing a data conversion program to convert vehicle data obtained from a provision source device in a vehicle into provision data suitable for an application is provided. When executed by at least one processor, the data conversion program causes the at least one processor to provide: a first processing unit that is configured to convert the vehicle data into first data in a predetermined format for each type of the vehicle data; a second processing unit that is configured to generate second data obtained by semanticizing at least one piece of the first data; and a provision unit that is configured to provide at least one of the first data or the second data to a memory or a provision destination device, which is determined in advance. data is transmitted in one direction according to an order of the first processing unit, the second processing unit, and the provision unit.

According to another aspect of the present disclosure, a data provision system comprises: a first control unit that is provided in a vehicle; and a second control unit that is provided in a cloud server. The first control unit or the second control unit provides a first processing unit configured to convert vehicle data obtained from a provision source device in the vehicle into first data in a predetermined format for each type of the vehicle data, a second processing unit configured to generate second data obtained by semanticizing at least one piece of the first data, and a provision unit configured to provide at least one of the first data or the second data to a memory or a provision destination device, which is determined in advance. Data is transmitted in one direction according to an order of the first processing unit, the second processing unit, and the provision unit.

According to another aspect of the present disclosure, a vehicle control device communicably connected to a plurality of other devices controlling control targets mounted on a vehicle is provided. The vehicle control device comprises: at least one processor; and a memory coupled to the at least one processor and storing program instructions that, when executed by the at least one processor, cause the at least one processor to provide: an input unit configured to acquire data regarding other devices, the data being transmitted from any of the plurality of other devices; a calculation unit configured to convert the data acquired by the input unit into standardization data in a predetermined format for each type of the data, and generate semantic data obtained by semanticizing at least one piece of the standardization data; and an output unit configured to transmit second data based on the semantic data to an application. Data is transmitted and received in one direction according to an order of the input unit, the calculation unit, and the output unit.

According to such a configuration, the first processing unit and the second processing unit can perform conversion into data suitable for the application of the provision destination device. Therefore, in a case where the application is changed, when a part of the data conversion program is changed, it is not necessary to change the control program on the vehicle side. Thus, there can be satisfactorily provided a configuration that can flexibly cope with addition or change of the application.

Hereinafter, embodiments of the present disclosure will be described with reference to the drawings.

### [1. Correspondence Relationship Between Configuration of Embodiment and Configuration of Present Disclosure]

API sections 7A to 7F in the embodiment correspond to a data conversion program in the present disclosure. Furthermore, an ECU 10 in the embodiment corresponds to a first control unit in the present disclosure, and a control unit 44 in the embodiment corresponds to a second control unit in the present disclosure.

Furthermore, base layers 70A to 70F in the embodiment correspond to a first processing unit and a first calculation unit in the present disclosure, and simple layers 72A to 72F in the embodiment correspond to a second calculation unit in the present disclosure. Furthermore, composite layers 74A to 74F in the embodiment correspond to a third calculation unit in the present disclosure, and second composite layers 78D to 78F in the embodiment correspond to a fourth calculation unit in the present disclosure. Furthermore, the simple layers 72A to 72F, a simple layer 76, and the composite layers 74A to 74F in the embodiment correspond to a second processing unit in the present disclosure. Furthermore, the composite layers 74A to 74F and the simple layer 76 in the embodiment correspond to a provision unit in the present disclosure.

### 2. First Embodiment

### [2-1. Configuration]

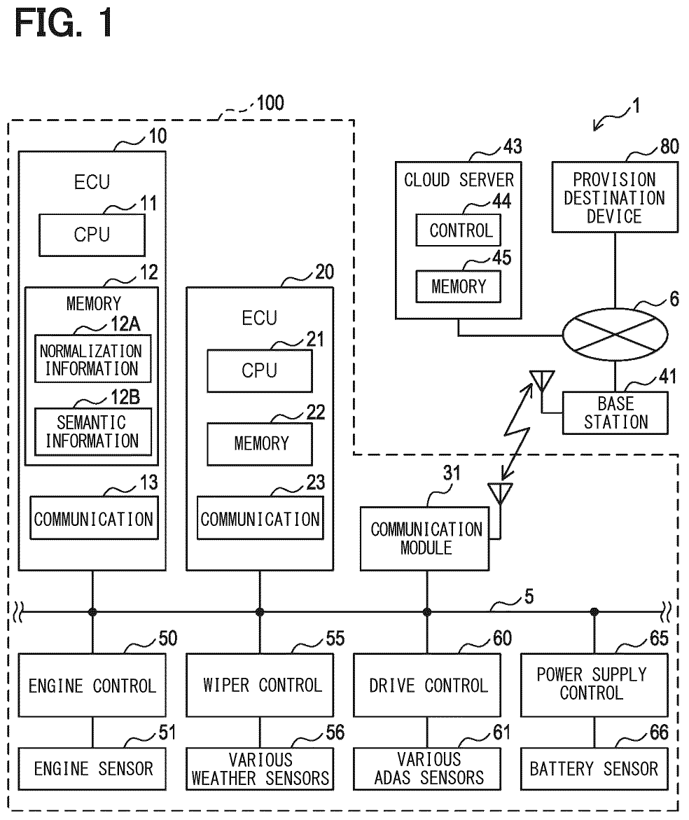

A data provision system 1 illustrated in FIG. 1 mainly includes a vehicle 100 such as a passenger vehicle, for example, and has a function of converting vehicle data obtained by sensor groups 51, 56, 61, and 66 (hereinafter, 51 to 66) of the vehicle 100 into an appropriate form and then providing the vehicle data to a provision destination device 80 or memories 12, 22, and 45.

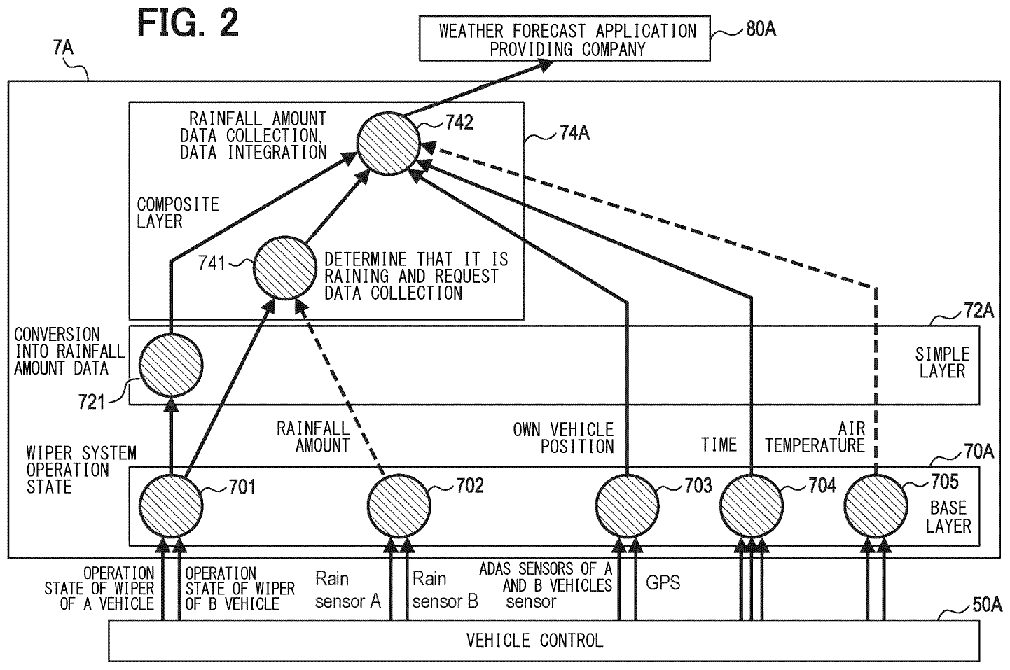

In the data provision system 1, for a change in service needs such as addition or update of an application that uses the vehicle data, the API section 7A (for example, see FIG. 2) is devised such that an influence on an existing system such as a program on the vehicle 100 side is minimized. With the API section 7A, a servicer who develops a service by using provision data (for example, a service provider who operates a service by using the provision destination device 80) can implement the service without being aware of a difference in vehicle specification (for example, differences in platform, onboard hardware, equipment, architecture, protocol, and the like).

As illustrated in FIG. 1, the data provision system 1 includes a vehicle 100 and a provision destination device 80. The data provision system 1 may include a cloud server 43.

The vehicle 100, the provision destination device 80, and the cloud server 43 are configured to be capable of communicating with each other via a base station 41 for wireless communication and an Internet network 6.

The cloud server 43 is configured as a known server, and includes a control unit 44 and a memory 45. The control unit 44 includes a known microcomputer including a CPU (not illustrated) and a semiconductor memory such as a RAM, a ROM, and a flash memory. Note that the control unit 44 may have some or all of the functions of the API section 7A. The memory 45 is used to temporarily store the provision data.

The provision destination device 80 is a device to which the provision data generated in the vehicle 100 is provided. The provision destination device 80 is, for example, a server of a weather forecast application providing company. In FIG. 2, the server of the weather forecast application providing company is denoted by a weather forecast application providing company 80A.

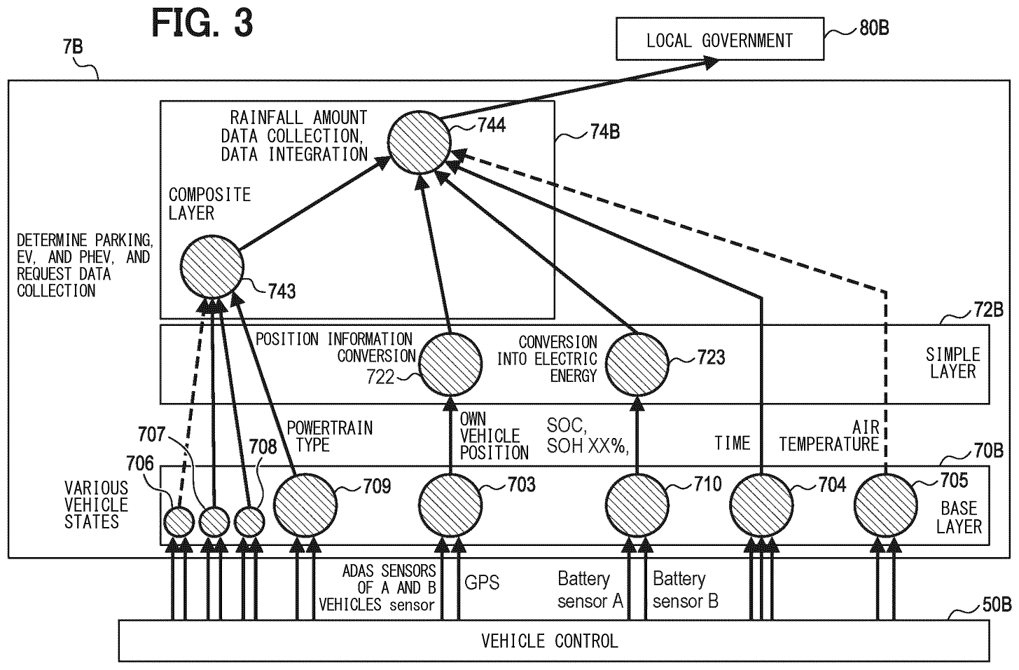

Note that the provision destination device 80 may be, for example, a server of a service provider such as a server of a local government, and an application of the server. In FIG. 3 and the following drawings, the server of the local government is denoted by a local government 80B. Furthermore, in the present embodiment, an example in which the ECU 10 provides the provision data to the provision destination device 80 will be described, but the ECU 10 may provide the provision data to memories 12 and 22 in the vehicle 100, the memory 45 in the cloud server 43, or the application.

In addition, the ECU 10 may provide the provision data to any application in the ECU 10, an application in an ECU 20, and an application in any other ECU in the vehicle 100.

The vehicle 100 includes a plurality of ECUs 10 and 20, various control units 50, 55, 60, and 65 (hereinafter, 50 to 65), and sensor groups 51 to 66. The ECU represents an electronic control device. The sensor groups 51 to 66 are connected to any of the various control units 50 to 65, and transmit vehicle data, which is data obtained by the vehicle 100 such as a sensor value, to the connected various control units 50 to 65.

The various control units 50 to 65 have a transfer function of acquiring vehicle data from a device such as a connected sensor and transferring the vehicle data to a plurality of the ECUs 10 and 20, and a control function of controlling the connected device. In the present embodiment, the control function will not be described, and the transfer function will be mainly described.

When viewed from a plurality of the ECUs 10 and 20, the various control units 50 to 65 are provision source devices serving as a provision source of the vehicle data. Note that the various control units 50 to 65 are not limited to the configuration of acquiring information from the sensor groups 51 to 66 of the vehicle 100, and may be configured to acquire information or the like from another ECU such as a body system of the vehicle 100 or another vehicle other than the vehicle 100 and transmit the information as vehicle data.

Examples of the various control units 50 to 65 include an engine control unit 50, a wiper control unit 55, a drive control unit 60, and a power supply control unit 65. Examples of the sensor groups 51 to 66 include an engine sensor 51, various weather sensors 56, various ADAS sensors 61, and a battery sensor 66.

The engine control unit 50 generates a digital value based on a detection value obtained from the engine sensor 51, and sends the digital value to the ECUs 10 and 20 via a communication line 5. Examples of the engine sensor 51 includes a crank angle sensor and an oxygen sensor.

The wiper control unit 55 generates a digital value based on a detection value obtained from each of the various weather sensors 56, and sends the digital value to the ECUs 10 and 20 via the communication line 5. The various weather sensors 56 have a function of acquiring an operation state of the wiper, a function as a rain sensor that detects the amount of raindrops, and the like.

The drive control unit 60 generates a digital value based on a detection value obtained from each of the various ADAS sensors 61, and sends the digital value to the ECUs 10 and 20 via the communication line 5. Examples of the various ADAS sensors 61 include a GPS sensor, a temperature sensor, a vehicle speed sensor, a gear position sensor, an acceleration sensor, and an angular velocity sensor. Note that GPS represents a global positioning system.

The power supply control unit 65 generates a digital value based on a detection value obtained from the battery sensor 66, and sends the digital value to the ECUs 10 and 20 via the communication line 5. The battery sensor 66 has a function of detecting an SOH and an SOC. Note that the SOH is an abbreviation of State of Health, and represents the soundness or deterioration state of the battery. Furthermore, the SOC is an abbreviation of State Of Charge, and represents a charging rate and a charging state of the battery.

Each of a plurality of the ECUs 10 and 20 mainly includes a known microcomputer including CPUs 11 and 21 and semiconductor memories 12 and 22 such as a RAM, a ROM, and a flash memory. Each of a plurality of the ECUs 10 and 20 includes communication units 13 and 23 for communicating with other ECUs and the various control units 50 to 65 via the communication line 5.

Various functions of a plurality of the ECUs 10 and 20 are implemented by the CPUs 11 and 21 executing a program stored in a non-transitory tangible recording medium. In this example, the memories 12 and 22 correspond to the non-transitory tangible recording medium storing the program. The program includes the API section 7A. Furthermore, by executing this program, a method corresponding to the program is executed. Note that the non-transitory tangible recording medium means a recording medium that does not use electromagnetic waves. Furthermore, the number of microcomputers constituting a plurality of the ECUs 10 and 20 may be one or more.

A plurality of the ECUs 10 and 20 have a function for converting vehicle data obtained from the sensor groups 51 to 66 into a form suitable for the provision destination device 80 as a part of various functions. In the present embodiment, a configuration in which a plurality of the ECUs 10 and 20 convert vehicle data and provides the converted vehicle data will be mainly described. Note that a plurality of the ECUs 10 and 20 may have a function of controlling devices in the vehicle 100 on the basis of the vehicle data.

Here, as an example, a functional configuration of the ECU 10, which is realized by the CPU 11 executing a program is illustrated in FIG. 2. Note that the description for the ECU 20 is omitted, but the ECU 20 may have a function similar to that of the ECU 10.

The functional configuration of the ECU 10 includes the API section 7A as illustrated in FIG. 2. Note that in FIGS. 2 to 4 and FIG. 8, the various control units 50 to 65 are collectively referred to as a vehicle control unit 50A. The vehicle control unit 50A represents at least one of the various control units 50 to 65.

The API section 7A is a program executed by at least one computer to convert vehicle data obtained from the sensor groups 51 to 66 in the vehicle 100 into provision data suitable for an application of the provision destination device 80. In the present embodiment, a case where the vehicle data obtained through the communication line 5 is CAN data will be described.

Note that CAN is an abbreviation for controller area network. The CAN is a registered trademark. The vehicle data obtained through the communication line 5 is not limited to the CAN data.

The API section 7A is a program that functions as an API for adapting a data format used by a program in the vehicle control unit 50A and a data format used by an application in the provision destination device 80. The API is an abbreviation for Application Programming Interface.

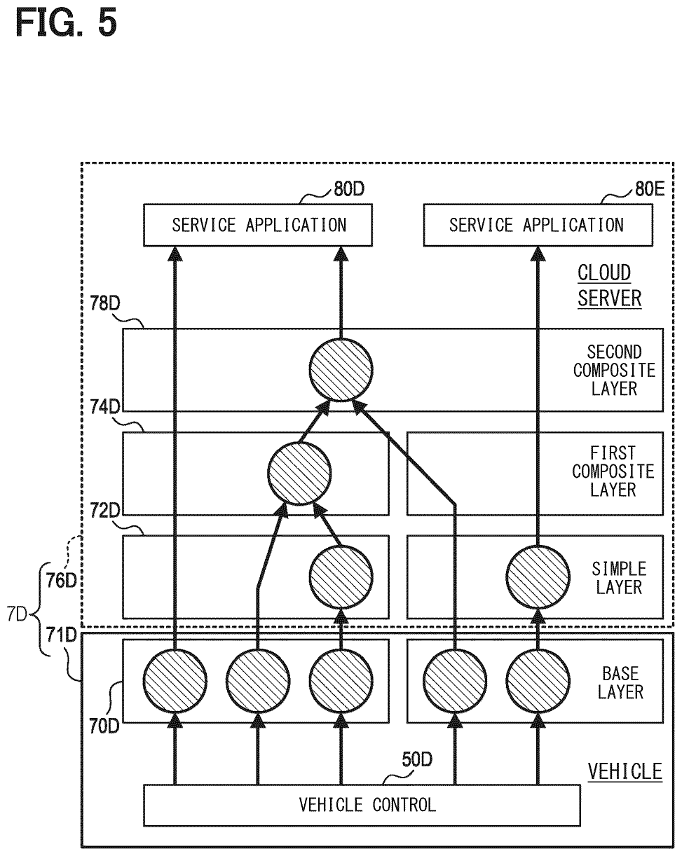

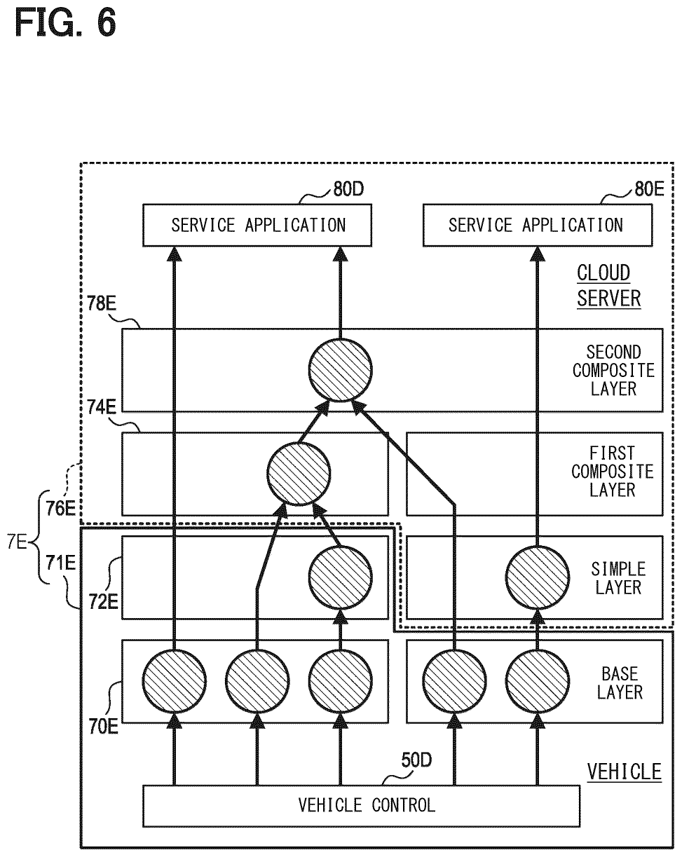

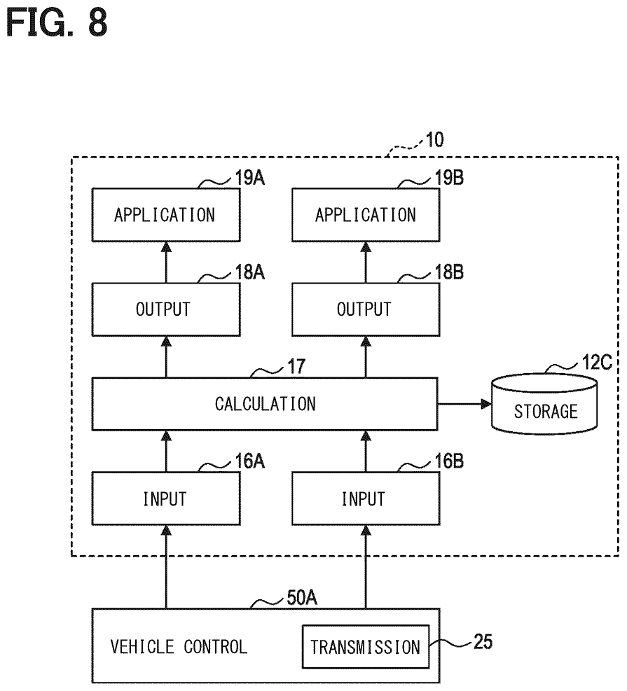

As illustrated in FIG. 8, the functional configuration of the ECU 10 includes a plurality of input units 16A and 16B (hereinafter, 16), a calculation unit 17, a plurality of output units 18A and 18B (hereinafter, 18), and a plurality of applications 19A and 19B (hereinafter, 19). A plurality of the input units 16, the calculation unit 17, and a plurality of the output units 18 function as the API section 7A (configuration of at least a part of the API sections 7B to 7F to be described later, in particular from base layers 70D and 70E to second composite layers 78D and 78E in FIGS. 5 and 6). Note that a plurality of the applications 19 may be provided outside the ECU 10. FIGS. 2 to 7 illustrate an example in which a plurality of the applications 19 are provided outside the ECU 10 (ECU 20, cloud server 43, provision destination device 80). Note that the vehicle control unit 50A may be provided in the ECU 10. In this case, the ECU 10 may be configured to control a sensor and an actuator.

A plurality of the applications 19 are programs for providing a service to a user of the vehicle and a user outside the vehicle. A plurality of the applications 19 provide useful functions to the user on the basis of information obtained from the vehicle 100. Note that a plurality of the applications 19 are not programs created specifically for vehicle types, grades, and the like, but are general-purpose programs that can support many vehicle types, grades, and the like.

Unlike a plurality of the applications 19, the vehicle control unit 50A includes a program created specifically for a vehicle type, a grade, and the like, and executes the program. As illustrated in FIG. 8, the vehicle control unit 50A includes a transmission unit 25. The transmission unit 25 is included in each vehicle control unit 50A. The transmission unit 25 transmits a value calculated by the vehicle control unit 50A and data obtained from the vehicle 100, for example, a sensor output value, an actuator control setting value, a response such as OK/NG, ack, and the like. The vehicle control unit 50A may have a function as a “reception unit” that receives a value from the sensor or the actuator.

A plurality of the input units 16 are programs having a function of acquiring and receiving data transmitted from the transmission unit 25 of the vehicle control unit 50A.

The calculation unit 17 is a program having a function of converting data acquired by each of the input units 16. For example, the calculation unit 17 is configured to convert the acquired data into standardization data in a format set in advance for each type of data, and generate semantic data obtained by semanticizing at least one piece of standardization data. The calculation unit 17 is configured to be capable of reading and writing data with respect to a storage unit 12C. For example, the storage unit 12C is configured as a part of a memory 12. The storage unit 12C functions as a storage space of data used when the CPU 11 performs a function as each layer of the base layer 70A, the simple layer 72A, and the composite layer 74A to be described later.

A plurality of the output units 18 are programs having a function of transmitting second data, which is at least one piece of data itself generated by the calculation unit 17 or data based on the data, to each of the applications 19. Note that in a case where each of the output units 18 transmits data to the outside of the ECU 10, the ECU 10 transmits the data by using the function of the communication unit 13.

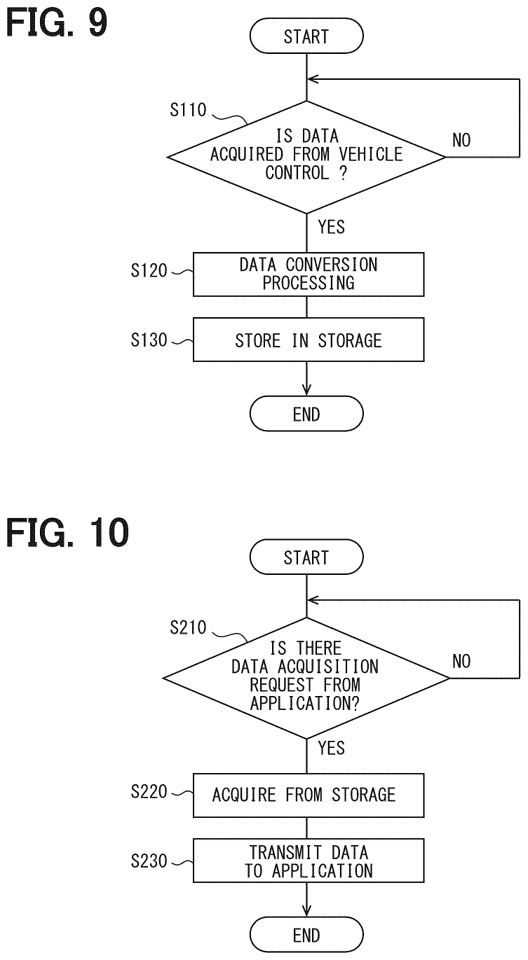

Here, data storage processing executed by the CPU 11 of the ECU 10 will be described with reference to FIG. 9. The data storage processing is processing indicating an example of functions as the input units 16 and the calculation unit 17, and for example, is processing that is started when the power of the vehicle 100 is turned on and then repeatedly performed.

In the data storage processing, first, the CPU 11 determines whether data has been acquired from the vehicle control unit 50A in S110. Note that the vehicle control unit 50A periodically or irregularly transmits data obtained by the vehicle 100. When the data is not acquired, the CPU 11 repeats the processing of S110.

When the data is acquired, the CPU 11 proceeds to S120 and performs data conversion processing. The data conversion processing is performed by performing a function as each layer of the base layer 70A, the simple layer 72A, and the composite layer 74A to be described later.

Next, in S130, the CPU 11 stores and preserves the data obtained by the data conversion processing in the storage unit 12C. When such processing ends, the data storage processing ends. Note that the CPU 11 may transmit the data obtained in the data conversion processing to the application 19 during the data conversion processing as in the processing of S230 to be described later. At this time, the CPU 11 may transmit the data to the pre-registered application 19.

Next, the data transmission processing executed by the CPU 11 of the ECU 10 will be described with reference to FIG. 10. The data transmission processing is processing indicating an example of a function as the output units 18, and for example, is processing that is started when the power of the vehicle 100 is turned on and then repeatedly performed.

In the data transmission processing, first, the CPU 11 determines whether there is a request for data from the application 19 in S210. When the data is not requested, the CPU 11 repeats the processing of S210. Furthermore, when the data is requested, the CPU 11 proceeds to S220 and acquires the data requested from the storage unit 12C.

Next, in S230, the CPU 11 transmits the acquired data to the application 19. When such processing ends, the data transmission processing ends. Note that when receiving a request from the application 19, the CPU 11 may acquire the newest data from the vehicle control unit 50A. In this case, the data conversion processing similar to that in S120 may be performed on the acquired newest data, and the data obtained by the data conversion processing may be transmitted in S230.

Details of the API section 7A will be described below. The same configuration can be adopted for an API section 7B and the like to be described later.

The API section 7A is configured by combining a plurality of programs respectively classified into the base layer 70A, the simple layer 72A, and the composite layer 74A. That is, in the present embodiment, a mechanism of subdividing the configuration of the API section 7A and connecting microservices, which are individual programs, with the API is realized by multilayering. With this configuration, even when the service needs are changed, the servicer can implement the service while minimizing the influence on the existing service.

The API section 7A is classified into three hierarchies in the order of the base layer 70A, the simple layer 72A, and the composite layer 74A. The composite layer may be further classified into two hierarchies. In the examples illustrated in FIGS. 5 to 7, the composite layer is classified into first composite layers 74D to 74F and second composite layers 78D to 78F. In each layer, in order from the vehicle control unit 50A side, the base layer 70A is a first layer, the simple layer 72A is a second layer, and the composite layer 74A is a third layer. In FIGS. 5 to 7, the first composite layers 74D to 74F are the third layers, and the second composite layers 78D to 78F are the fourth layers. In the API section 7A, data is transmitted and received in one direction from the first layer to the fourth layer according to the order of layers.

The base layer 70A has a function of converting data acquired by the input units 16 into standardization data in a format set in advance for each type of data. For example, the base layer 70A may have a function of receiving a notification from ECUs (for example, ECUs related to a sensor and an actuator, such as ECUs 141 to 148 respectively including control units 191 to 199 to be described later). Furthermore, the base layer 70A may have a function of converting data obtained from the individual vehicles 100 into a data value that can be commonly used by each vehicle. Specifically, for example, the base layer 70A may normalize a unit, a range, a resolution, and the like with respect to a payload value of a CAN frame, and convert the normalized unit, range, resolution, and the like into a physical value that can be used in common for each vehicle.

The simple layer 72A has a function of converting the standardization data into definition data that is a predefined value. That is, the simple layer 72A has a function of converting data generated by the base layer 70A into semantic data. Specifically, for example, the simple layer 72A converts a wiper control amount within the range of 0 to 255 into “high speed/medium speed/low speed”, which is the operation speed of the wiper. Moreover, for example, in a case where the wiper is operated at “high speed”, the intensity of rain is converted into “heavy rain”.

The composite layer 74A has, as a function of a first composite layer (that is, the third layer), a function of generating first integration data which is data aggregated or integrated in the domain by using the standardization data or the definition data. This function includes “semanticizing” to be described later. Note that the domain represents a unit and a region when the control system is separated. In other words, for example, it represents a range or the like in which common data can be used for each control target. For example, in a case where the data used in the drive system for driving a motor cannot be recognized or used in an HMI system for controlling a display, the drive system and the HMI system are in different domains.

For example, the composite layer 74A has a function of integrating vehicle data related to vehicle motion (for example, run, turn, stop) in the domain of the drive system. That is, data structuring is performed. Furthermore, for example, the composite layer 74A has a function of converting fuel consumption from the vehicle data in the domain of the drive system.

In addition, the composite layer 74A has, as a function of the second composite layer (that is, the fourth layer), a function of generating second integration data which is data integrated across the domains by using the standardization data, the definition data, or the first integration data. This function also includes “semanticizing” to be described later.

The composite layer 74A aggregates or integrates driver state data obtained from, for example, the HMI system (for example, a driver monitor), the drive system (for example, a motor), and the like. That is, the composite layer 74A processes data across the domains of vehicle control.

The composite layer 74A acquires a battery usage amount from the domains such as the HMI system (for example, a display), the body system (for example, a light or an air conditioner), and the drive system (for example, a motor), and aggregates or integrates the acquired data. Note that the composite layer 74A may have a cross-domain function of exchanging data across the domain of the vehicle 100 and the domain of the environment.

Specifically, the base layer 70A is a program for converting the vehicle data into first data in a format set in advance for each type of the vehicle data. For example, as illustrated in FIG. 2, examples of the program classified as the base layer 70A include at least one of a wiper extraction section 701, a rainfall amount extraction section 702, a position extraction section 703, a time extraction section 704, or an air temperature extraction section 705.

Each of the extraction sections 701 to 705 is configured as an independent program. Therefore, in a case where the type of data required by the application in the provision destination device 80 is changed, it is easy to add or delete the program belonging to the base layer 70A. With this configuration, even in a case where the type of data required by the application is changed, it is possible to easily cope with the change only by changing a part of the API section 7A without changing the various control units 50 to 65 of the vehicle 100. In other words, since the API section 7A is configured such that a data interface for the vehicle control unit 50A can be added or changed in the base layer 70A, even when there is a difference in vehicle type (that is, hardware), the servicer side can realize the service without being aware of the difference.

Each of the extraction sections 701 to 705 is a program having a function of monitoring data flowing through the communication line 5, extracting only a data frame of a preset type from the communication line 5, and standardizing a data format. Standardization is also called formatting.

In the standardization performed by each of the extraction sections 701 to 705, the data frame flowing through the communication line 5 is converted into a data format conforming to a CAN frame. In the data format conforming to the CAN frame, for example, the data order is the same arrangement order as that of the CAN frame, and represents a data frame obtained by removing a header, a footer, and the like from the CAN frame.

The standardized data frame includes, for example, an ID indicating a data type, data length information, actual data (that is, a payload), and an error correction code, and each data has a data format which is common, that is, a common data format. That is, the first data standardized by each of the extraction sections 701 to 705 has a common data format in which a frame structure is made common.

More specifically, the wiper extraction section 701 extracts information indicating the operation state of the wiper, for example, the information indicating that the operation speed of the wiper indicates high speed, medium speed, low speed, or stop from the data flowing through the communication line 5, and performs standardization. That is, before and after the standardization, the actual data (for example, a raw value representing the sensor value itself) in the data frame is converted into the common data format without being changed. Note that each of the extraction sections 701 to 705 may execute at least some of the functions of the semanticizing to be described later.

The rainfall amount extraction section 702 extracts a raindrop amount, in other words, information regarding the rainfall amount, from the data flowing through the communication line 5, and performs standardization.

The position extraction section 703 extracts a latitude and longitude where the vehicle 100 is located, in other words, position information, from the data flowing through the communication line 5, and performs standardization.

The time extraction section 704 extracts information regarding a time, from the data flowing through the communication line 5, and performs standardization.

The air temperature extraction section 705 extracts information regarding an air temperature from the data flowing through the communication line 5, and performs standardization.

The simple layer 72A and the composite layer 74A each include at least one program. These programs are configured independently. The simple layer 72A and the composite layer 74A are programs for semanticizing at least one type of first data and generating second data obtained as a result of the semanticizing.

The semanticizing is processing of converting data such that the meaning of the data can be understood without being compared with other data. Note that the semanticizing may include digitization that expresses data that is not a numerical value as a numerical value, and unit assignment that adds a unit to a numerical value having no unit.

The semanticizing may include the following processing. The semanticizing includes, for example, processing of digitizing a payload with a value of “100” digitized for every “0.5 km/h” into “50 km/h” which is a vehicle speed, and processing of adding a unit of “km/h” to a value of “50” having no unit. Furthermore, the semanticizing includes converting a payload with a value of “0, 1, 2” into “D”, “P”, “R”, or the like representing a shift range. Furthermore, the semanticizing also includes generating data having another meaning (for example, the rainfall amount) from data already having a specific meaning (for example, wiper operation).

The simple layer 72A is a program for semanticizing one type of first data, and the composite layer 74A is a program for semanticizing these first data by using two or more types of first data.

In the API section 7A, data is transmitted and received in one direction according to the order of the base layer 70A, the simple layer 72A, and the composite layer 74A. That is, in principle, the calculation result in each of the layers 70A, 72A, and 74A is transmitted to the higher layer so as to be used only in the higher layer.

In the example illustrated in FIG. 2, the calculation result in the base layer 70A is not used in the base layer 70A, but is used in the simple layer 72A and the composite layer 74A. Furthermore, the simple layer 72A uses the calculation result in the base layer 70, and the calculation result is used in the composite layer 74A without being used in the base layer 70A and the simple layer 72A. Furthermore, the composite layer 74A uses the calculation results of the base layer 70 and the simple layer 72A.

Note that in the composite layer 74A, the calculation result in a rain determination section 741 is used by an integration section 742 which is another program in the same composite layer 74A, but the calculation result of the integration section 742 is not used by the rain determination section 741.

More specifically, in the present embodiment, the base layer 70A, the simple layer 72A, and the composite layer 74A are formed in order from the side closer to the various control units 50 to 65, and each layer, in particular, the composite layer 74A may be further multiply hierarchized for each program. For example, the rain determination section 741 may be the first composite layer, and the integration section 742 may be the second composite layer above the first composite layer.

The base layer 70A performs calculation based on raw values of data received from the various control units 50 to 65 to generate first data. The simple layer 72A performs calculation based on the first data received from the base layer 70A to generate second data.

The composite layer 74A performs calculation based on at least one of the first data received from the base layer 70A or the second data received from the simple layer 72A to generate third data. The first data, the second data, and the third data, which are calculation results, are used in a layer higher than the layer in which the calculation is performed. The first data, the second data, and the third data are not used in the same layer as the layer in which the calculation is performed and layers below the same layer as the layer in which the calculation is performed.

The simple layer 72A and the composite layer 74A perform processing for semanticization by using normalization information 12A and semantic information 12B, which are prepared in advance. For example, the normalization information 12A and the semantic information 12B are recorded in advance in the memory 12.

Normalization means that conversion is performed such that the same physical quantity becomes the same value regardless of the vehicle type and the vehicle manufacturer. The normalization information 12A is information for normalizing extraction data. The semantic information 12B is information (for example, a calculation formula and a conversion table) for performing conversion into semantic data by using normalized data. When the semantic information 12B is used, vehicle data before normalization may be used. The semanticizing includes newly generating information that is not in the payload of the communication frame by using a calculation formula or the like.

For example, the normalization information 12A may include, as setting items, “CANID”, “ECU”, “Position”, “DLC”, “Unique label”, “Resolution”, “Offset”, and “Unit”. These pieces of information are described in the conversion table for data items.

“ECU” is identification information indicating an ECU as a transmission source of the CAN frame. For example, “ENG” indicates an engine ECU.

“Position” is information indicating a position (for example, a bit position) of the CAN data in a data field. “DLC” is information indicating a data length. DLC is an abbreviation for Data Length Code. That is, “DLC” bits of data are extracted from “Position” of the data field.

“Unique label” is information indicating a control label. For example, “ETHA” indicates an intake air temperature, and “NE1” indicates an engine speed. “Resolution” is information indicating a numerical value per bit. “Offset” indicates an offset amount of a numerical value of the data. “Unit” indicates a unit of the data.

Therefore, data corresponding to “Unique level” is extracted from the standard format data according to “CANID”, “ECU”, “Position”, “DLC”, and “Unique label”. Moreover, the extracted data is converted into data represented by “Resolution”, “Offset”, and “Unit”.

Furthermore, the semantic information 12B is, for example, a conversion formula for converting information of “Operation state of wiper/high speed” into information of “Rainfall amount”. “Unique label”, “Unit”, and the like are assigned to data newly generated by semanticizing. That is, the meaning of the semanticized second data can be understood without comparing with other data.

For example, a case where data related to steering is received will be described.

The semantic information 12B is, for example, a conversion formula for performing conversion into a “steering angle” by subtracting a “steering zero point” with the control label of “SSAZ” from a “steering movement angle” with the control label of “SSA”. Accordingly, data representing the “steering movement angle” and data representing the “steering zero point” are converted into data representing the “steering angle” having the meaning of a “steering amount from a reference position”. “Unique label”, “Unit”, and the like are assigned to data newly generated by semanticizing. That is, the meaning of the semanticized data can be understood without comparing with other data.

The simple layer 72A includes a rainfall amount section 721. The rainfall amount section 721 recognizes whether the operation state of the wiper is any of high speed, medium speed, low speed, and stop on the basis of the first data from the wiper extraction section 701, and converts the operation state of the wiper into the rainfall amount on the basis of a preset conversion formula. For example, when the operation state of the wiper is high speed, the rainfall amount is calculated to be 30 mm/h.

The composite layer 74A includes the rain determination section 741 and the integration section 742. The rain determination section 741 determines whether it is raining and determines the rainfall amount by using the first data from the wiper extraction section 701 and the rainfall amount extraction section 702.

The integration section 742 generates data required by the provision destination device 80 and transmits the generated data to the provision destination device 80. The integration section 742 combines information regarding whether it is raining and information regarding the rainfall amount, which are obtained by the rain determination section 741, and information regarding the rainfall amount, which is obtained by the rainfall amount section 721, and recognizes the information regarding the rainfall amount more accurately. Then, provision data is generated by combining the information regarding the rainfall amount with position information obtained by the position extraction section 703, information regarding a time obtained by the time extraction section 704, and information regarding an air temperature obtained by the air temperature extraction section 705.

The composite layer 74A, in particular, the integration section 742 transmits the provision data at a timing required by the provision destination device 80. For example, in the integration section 742, a collection condition for data and a provision condition for data are set in advance, data corresponding to the collection condition is generated, and the provision data is transmitted at a timing determined in the provision condition. As the collection condition, an environment such as weather, an operation of a specific part of the vehicle 100, such as a wiper, a traveling state of the vehicle 100, such as a vehicle speed, and the like can be arbitrarily set. Note that in the rain determination section 741, a collection condition for data and a provision condition for data are set in advance, the rain determination section 741 may generate data corresponding to the collection condition, and transmit the provision data at a timing determined in the provision condition.

More specifically, in a case where “only in a case where it is raining” is set as the collection condition, the integration section 742 can cause the processing of generating the provision data not to be performed when the wiper is not operating or no raindrop is detected. In this case, the provision data is not provided to the provision destination device 80. Furthermore, as the provision condition, a collection cycle of data, a provision cycle of data, the number of pieces of data, and the like can be set. Even in a case where the data corresponds to the collection condition, in a case where the data does not correspond to the collection cycle for data, the integration section 742 can similarly cause the processing of generating the provision data not to be performed.

Furthermore, the integration section 742 is configured to store the provision data in the memory 12 in a case where the provision data does not correspond to the provision cycle for data even when the provision data is generated, and transmit the provision data in the memory 12 to the provision destination device 80 when the provision timing arrives.

Furthermore, the provision destination device 80 is configured to be capable of transmitting a request to the ECU 10, and the integration section 742 may transmit the provision data in a case where the request from the provision destination device 80 is received. Note that the integration section 742 may transmit the first data generated in the base layer 70A to the provision destination device 80.

### [2-3. Effect]

According to the first embodiment described above, the following effects are obtained.

(2a) An aspect of the present disclosure is the API section 7A as a program executed by at least one computer to convert the vehicle data obtained from the various control units 50 to 65 in the vehicle 100 into provision data suitable for the application. The API section 7A has functions as the base layer 70A, the simple layer 72A, and the composite layer 74A.

The base layer 70A is configured to convert the vehicle data into first data in a format set in advance for each type of the vehicle data. The simple layer 72A and the composite layer 74A are configured to generate second data obtained by semanticizing at least one type of first data.

According to such a configuration, the base layer 70A, the simple layer 72A, and the composite layer 74A can be converted into data suitable for the application of the provision destination device 80. Therefore, in a case where the application is changed, when a part of the API section 7A is changed, it is not necessary to change a control program on the vehicle side. Thus, there can be satisfactorily provided a configuration that can flexibly cope with addition or change of the application.

(2b) In the embodiment described above, each of the sections 701 to 705, 721, and 741 to 742 included in the base layer 70A, the simple layer 72A, and the composite layer 74A functions as a “function”. The “function” is a software module as a program. Note that a part of the function may be realized by hardware such as a circuit.

Each function may be provided corresponding to each data type of a group (for example, a wiper system, a rain sensor system, or the like).

Raw values of data transmitted from the various control units 50 to 65 are transmitted to one function of the base layer 70A. The first data transmitted from the base layer 70A is transmitted to one function of the simple layer 72A and one function of the composite layer 74A. The second data transmitted from the simple layer 72A is transmitted to one function of the composite layer 74A. That is, data transmitted from the lower layer is not transmitted to a plurality of functions in the same layer. Note that the composite layer 74A may be used as a configuration including layers different from the first composite layer and the second composite layer.

According to such a configuration, for example, in a case where it is necessary to change into the wiper extraction section 701, which is one of the functions of the base layer 70A, the number of configurations that is changed accordingly can be reduced. That is, the change can be made only in the rainfall amount section 721 which is a function of the simple layer 72A and the rain determination section 741 which is a function of the first composite layer of the composite layer 74A.

(2c) In the aspect of the present disclosure, the composite layer 74A is configured to provide at least one of the first data or the second data to the preset provision destination device 80.

According to such a configuration, arbitrary data generated by the API section 7A can be provided to the provision destination device 80.

(2d) In the aspect of the present disclosure, in the composite layer 74A and the simple layer 76, whether to provide data is set according to the preset collection condition.

According to such a configuration, it is possible to set whether to provide data according to the collection condition.

(2e) In the aspect of the present disclosure, it is configured such that data is transmitted and received in one direction according to the order of the base layer 70A, the simple layer 72A, and the composite layer 74A.

According to such a configuration, the flow of data from the various control units 50 to 65 to the application can be unidirectional. Therefore, the processing related to the API section 7A can be prevented from entering an infinite loop.

(2f) An aspect of the present disclosure is the data provision system 1 including: the ECU 10 as the first control unit provided in the vehicle 100; and a control unit 44 as the second control unit provided in the cloud server 43. The data provision system 1 includes the base layer 70A, the simple layer 72A, and the composite layer 74A.

The base layer 70A is configured to convert the vehicle data into first data in a format set in advance for each type of the vehicle data. The simple layer 72A and the composite layer 74A are configured to generate second data obtained by semanticizing at least one type of first data.

According to such a configuration, the base layer 70A, the simple layer 72A, and the composite layer 74A can generate and provide data suitable for the application of the provision destination device 80. Note that the base layer 70A, the simple layer 72A, and the composite layer 74A may be provided in any of the ECU 10 and the control unit 44.

### 3. Second Embodiment

[3-1. Difference from First Embodiment]

Since the basic configuration of the second embodiment is similar to that of the first embodiment, differences will be described below. Note that the same reference numerals as those in the first embodiment indicate the same configuration, and reference is made to the preceding description.

In the first embodiment described above, information regarding the rainfall amount is provided. On the other hand, the second embodiment is different from the first embodiment in that information regarding electric energy is provided.

### [3-2. Configuration]

In the second embodiment, an API section 7B is provided instead of the API section 7A. The API section 7B includes a base layer 70B, a simple layer 72B, and a composite layer 74B.

The base layer 70B of the second embodiment includes a vehicle speed extraction section 706, a gear position extraction section 707, an IG extraction section 708, a powertrain extraction section 709, and an electric energy extraction section 710 instead of the wiper extraction section 701 and the rainfall amount extraction section 702 of the first embodiment.

The vehicle speed extraction section 706 extracts a vehicle speed from the data flowing through the communication line 5, and performs standardization.

The gear position extraction section 707 extracts a gear position, in other words, whether a shift position is a drive position, a neutral position, a reverse position, a parking position, or the like from the data flowing through the communication line 5, and performs standardization.

The IG extraction section 708 extracts IG, that is, whether the ignition is on or off, from the data flowing through the communication line 5, and performs standardization.

The powertrain extraction section 709 extracts the type of powertrain of the vehicle 100, that is, whether the vehicle 100 is a gasoline vehicle, a hybrid vehicle, an electric vehicle, a fuel cell vehicle, or the like from the data flowing through the communication line 5, and performs standardization.

The electric energy extraction section 710 extracts an SOH and an SOC of a battery mounted on the vehicle 100 from the data flowing through the communication line 5, and performs standardization.

The simple layer 72B includes a position conversion section 722 and an electric energy conversion section 723. The position conversion section 722 recognizes which address corresponds to the latitude and longitude of the vehicle 100, and converts the latitude and longitude into an address. Note that the granularity of the address after conversion, for example, whether to be “Kariya-shi, Aichi-ken” or “Showa-cho, Kariya-shi, Aichi-ken” can be arbitrarily set.

The electric energy conversion section 723 converts the SOH and the SOC of the battery into absolute electric energy (for example, xx kWh).

The composite layer 74B includes a collection section 743 and an integration section 744. The collection section 743 determines whether the vehicle is traveling and the type of powertrain, and requests the integration section 744 to collect data according to the type of powertrain in a case where the collection condition is satisfied.

The integration section 744 acquires data corresponding to the request from the collection section 743 from the simple layer 72B and the base layer 70B, and generates provision data obtained by integrating these pieces of data. Then, the integration section 744 transmits the provision data to a local government 80B.

### [3-3. Effect]

According to the second embodiment described above, the effect (2a) of the first embodiment described above is obtained.

### 4. Third Embodiment

[4-1. Difference from Second Embodiment]

In the second embodiment, the vehicle 100 independently provides data to a local government 80B. On the other hand, the third embodiment is different from the second embodiment in that the vehicle 100 and the cloud server 43 cooperate to provide data.

### [4-2. Configuration]

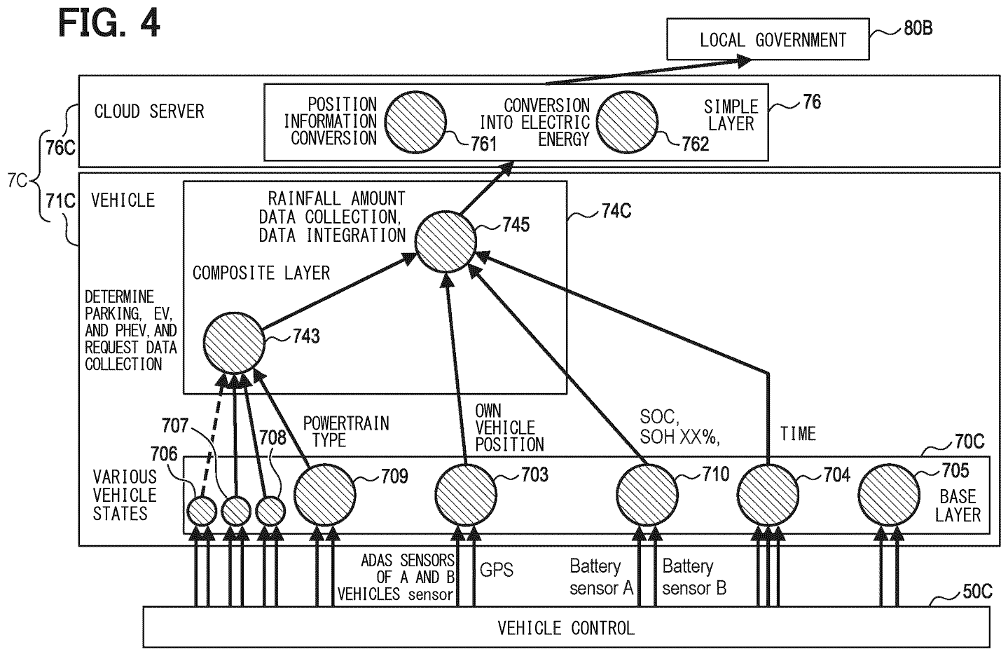

In the third embodiment, as illustrated in FIG. 4, an API section 7C is provided. The API section 7C is disposed in a dispersed manner in the vehicle 100 and the cloud server 43 outside the vehicle 100. Specifically, the API section 7C includes a vehicle-side section 71C and a cloud-side section 76C.

The vehicle-side section 71C includes a base layer 70C and a composite layer 74C. The cloud-side section 76C includes a simple layer 76.

The base layer 70C is configured similarly to the base layer 70B of the second embodiment. The composite layer 74C includes the collection section 743 described above and a new integration section 745. The integration section 745 is different from the integration section 744 of the second embodiment in that the SOH and the SOC of the battery are acquired as they are. The integration section 745 generates second data obtained by integrating the acquired data, and sends the second data to the cloud server 43.

The simple layer 76 of the cloud-side section 76C includes a position conversion section 761 and an electric energy conversion section 762. The position conversion section 761 and the electric energy conversion section 762 have a function similar to the position conversion section 722 and the electric energy conversion section 723 in the second embodiment. However, the position conversion section 761 and the electric energy conversion section 762 use data provided from the vehicle 100. In addition, the position conversion section 761 and the electric energy conversion section 762 have a function of generating provision data and transmitting the generated provision data to the local government 80B.

### [4-3. Effect]

According to the third embodiment described above, the effect (2a) of the first embodiment described above is obtained, and the following effect is further obtained.

(4a) In the aspect of the present disclosure, the API section 7C is disposed in a dispersed manner in the vehicle 100 and the cloud server 43 outside the vehicle 100.

According to such a configuration, in a configuration in which the API section 7C is disposed in a dispersed manner in the vehicle 100 and the cloud server 43 outside the vehicle 100, it is possible to satisfactorily provide data required by the application.

(4b) In the aspect of the present disclosure, the base layer 70C and the composite layer 74C are disposed in the vehicle 100, and the simple layer 76 is disposed in the cloud server 43.

Even with such a configuration, it is possible to satisfactorily provide data required by the application.

### 5. Other Embodiments

Although the embodiments of the present disclosure have been described above, the present disclosure is not limited to the above-described embodiments, and various modifications can be made.

(5a) In the first embodiment, the API section 7A is provided in the vehicle 100, and the provision data is directly provided to the provision destination device 80, but the present disclosure is not limited thereto. For example, the API section 7A of the vehicle 100 may transmit the provision data to the cloud server 43, the cloud server 43 may temporarily hold the provision data, and then the cloud server 43 may transmit the provision data to the provision destination device 80.

Even with such a configuration, it is possible to satisfactorily provide data required by the application.

(5b) In the third embodiment, the base layer 70C and the composite layer 74C are disposed in the vehicle 100, and the simple layer 76 is disposed in the cloud server 43, but the present disclosure is not limited to this configuration. For example, an API section 7D illustrated in FIG. 5 may be configured. FIG. 5 illustrates a configuration in which the API section 7D generates provision data on the basis of the vehicle data obtained from a vehicle control unit 50D and transmits the provision data to service applications 80D and 80E disposed in an arbitrary device as the provision destination device 80.

The API section 7D is divided into a vehicle-side section 71D on the vehicle 100 side and a cloud-side section 76D on the cloud server 43 side and disposed. A base layer 70D is disposed in the vehicle-side section 71D, and a simple layer 72D and composite layers 74D and 78D are disposed in the cloud-side section 76D. Note that the composite layers 74D and 78D may be separated as different layers according to functions, for example, a first composite layer 74D and a second composite layer 78D.

(5c) Moreover, for example, an API section 7E illustrated in FIG. 6 may be configured. In the API section 7E, a part of a base layer 70E and a simple layer 72E may be disposed in a vehicle-side section 71E. Furthermore, another part of the simple layer 72E and composite layers 74E and 78E may be disposed in the cloud-side section 76E.

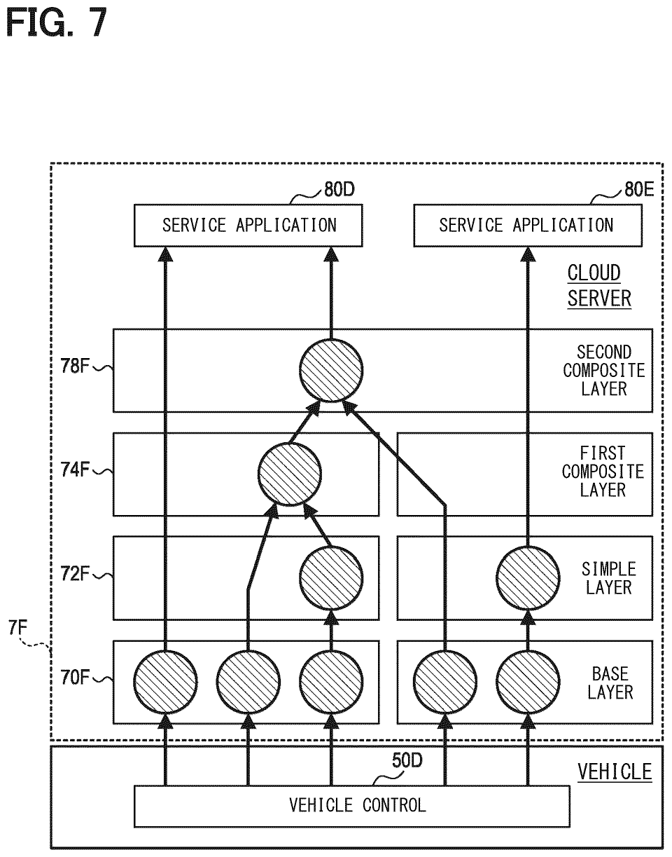

(5d) Moreover, for example, an API section 7F illustrated in FIG. 7 may be configured. In the API section 7F, a base layer 70F, a simple layer 72F, and composite layers 74F and 78F may be disposed in the cloud server 43. In this case, the vehicle data may be directly transmitted from the vehicle control unit 50D to the cloud server 43.

Even with these configurations, it is possible to satisfactorily provide data required by the application.

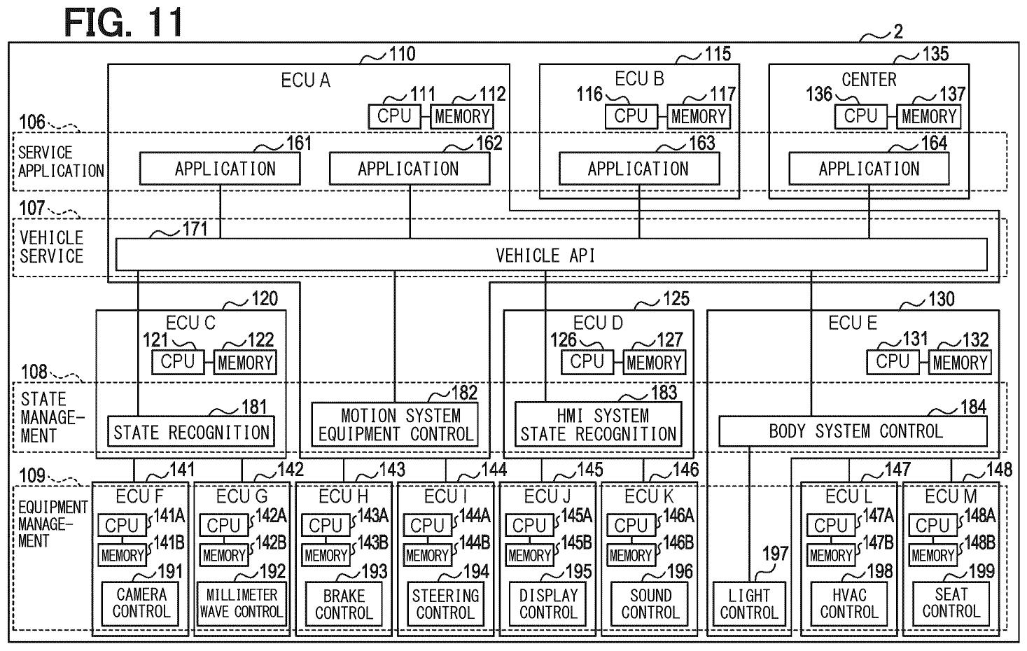

(5e) The above-described configuration can be implemented as, for example, a specific configuration as illustrated in FIG. 11. Note that a vehicle service section 107 illustrated in FIG. 11 has a function corresponding to the second composite layers 78D to 78F described above, and a state management section 108 has a function corresponding to the base layers 70A to 70F, the simple layers 72A to 72F, and the first composite layers 74A to 74F, which are described above.

A vehicle control system 2 illustrated in FIG. 11 has most of the configurations mounted on a vehicle, and includes a plurality of ECUs 110, 115, 120, 125, 130, 141 to 148 (hereinafter, a large number of ECUs 110 and the like). The vehicle control system 2 may include a center 135 outside the vehicle.

The center 135 is configured as a server capable of providing a function to the vehicle. For example, the center 135 can provide the vehicle with a function related to automatic driving.

Each of a large number of the ECUs 110 and the like and the center 135 mainly includes a known microcomputer including CPUs 111, 116, 121, 126, 131, and 136 (hereinafter, CPUs 111 to 136) and a semiconductor memories 112, 117, 122, 127, 132, and 137 (hereinafter, memories 112 to 137) such as a RAM, a ROM, and a flash memory. Furthermore, each of the ECUs 141 to 148 includes CPUs 141A, 142A, 143A, 144A, 145A, 146A, 147A, and 148A, and memories 141B, 142B, 143B, 144B, 145B, 146B, 147B, and 148B.

A large number of the ECUs 110 and the like and the center 135 are configured to control a control target mounted on the vehicle. The control target corresponds to, for example, an actuator such as an engine, a brake, a motor, various lights, a display device, an air conditioner, a seat, a horn, or a power generator, or a sensor such as a camera or a millimeter wave. Note that illustration of the control target is omitted.

The control target is individually controlled by the ECUs 141 to 148 which are operation control devices. Examples of the ECUs 141 to 148 include an ECUF 141 including a camera control unit 191, an ECUG 142 including a millimeter wave control unit 192, an ECUH 143 including a brake control unit 193, and an ECUI 144 including a steering control unit 194. Furthermore, examples of the ECUs 141 to 148 include an ECUJ 145 including a display control unit 195, an ECUK 146 including a sound control unit 196, an ECUL 147 including an HVAC control unit 198, and an ECUM 148 including a seat control unit 199.

Each of the control units 191 to 199 includes an operation control program for operating a control target. The camera control unit 191 acquires a captured image of an in-vehicle camera and controls exposure and the like of the in-vehicle camera. The millimeter wave control unit 192 controls a millimeter wave radar provided in the vehicle and acquires a detection result obtained by the millimeter wave radar.

The brake control unit 193 controls a brake. The steering control unit 194 controls steering. The display control unit 195 controls an indicator such as a meter or a warning light. The sound control unit 196 controls a sound such as a warning sound and a voice generated from a speaker. A light control unit 197 controls various lights mounted on the vehicle. Note that the light control unit 197 is included in the ECUE 130.

The HVAC control unit 198 controls an in-vehicle air conditioner. Note that HVAC is an abbreviation for Heating Ventilation and Air-Conditioning. The seat control unit 199 controls an electric power seat of the vehicle.

Various functions of a large number of the ECUs 110 and the center 135 are implemented by the CPUs 111 to 131 executing a program stored in a non-transitory tangible recording medium. In this example, the memories 112 to 132 correspond to the non-transitory tangible recording medium storing the program. Furthermore, by executing this program, a method corresponding to the program is executed. Note that the non-transitory tangible recording medium means a recording medium that does not use electromagnetic waves. Furthermore, the number of microcomputers constituting a large number of the ECUs 110 and the like and the center 135 may be one or more.

Among a large number of ECUs 110 and the like, the ECUA 110 executes a program to implement functions as applications 161 and 162, a vehicle API 171, and a motion system equipment control unit 182. The ECUB 115 implements a function as an application 163. The center 135 implements a function as an application 164.

The applications 161 to 164 are programs for providing a service to a user of the vehicle. The applications 161 to 164 indirectly transmit a command to the control target and provide a useful function to the user by operating the control target. These applications 161 to 164 may be installed in the ECUA 110, the ECUB 115, or the center 135.

More specifically, the applications 161 to 164 are configured to generate a first command that is a command not directly designating the control units 191 to 199 to be described later with respect to the vehicle API 171. Note that the “command” includes a command such as an operation request, a command such as an argument, and a function call among data used by the vehicle API 171. The “command” may include priority information indicating which command is to be preferentially processed.

The applications 161 to 164 are not programs created specifically for vehicle types, grades, and the like, but are general-purpose programs that can support many vehicle types, grades, and the like. Thus, the applications 161 to 164 cannot specify how the vehicle in which the applications are installed controls the control target. Therefore, the applications 161 to 164 output a specific control amount of the control target, in other words, a command not designating the control units 191 to 199 used by the vehicle API 171. On the other hand, the applications 161 to 164 generate a desired abstract operation content. For example, the applications 161 to 164 only instruct the operation content to turn on the light in an automatic mode, and the operation content indicating that specifically which light is turned on is not included.

Hereinafter, at least one of the applications 161 to 164 is also referred to as a service application 106.

Unlike the applications 161 to 164, the vehicle API 171 is a program created specifically for a vehicle type, a grade, and the like. That is, the vehicle API 171 is a program that absorbs differences in vehicle type, grade, and the like such that the applications 161 to 164 do not need to recognize the differences in vehicle type, grade, and the like. The vehicle API 171 is a program that functions as an API for adapting a command used by the applications 161 to 164 and a command used by the state management section 108 and an equipment management section 109 to be described later.

The vehicle API 171 is installed in the ECUA 110. The vehicle API 171 receives commands from a plurality of the applications 161 to 164 installed in the ECUA 110 that is the vehicle API 171, the ECUB 115 that is another ECU, and the center 135.

Hereinafter, at least one of the vehicle APIs 171 is also referred to as a vehicle service section 107. Note that the vehicle service section 107 may include a plurality of vehicle APIs.

Here, the ECUC 20 implements a function as a state recognition unit 181. The ECUD 25 implements a function as an HMI system state recognition unit 183. The ECUE 130 implements a function as a body system control unit 184. Hereinafter, at least one of the state recognition unit 181, the motion system equipment control unit 182, the HMI system state recognition unit 183, or the body system control unit 184 is also referred to as a state management section 108. The state recognition unit 181, the motion system equipment control unit 182, the HMI system state recognition unit 183, and the body system control unit 184 correspond to the domains of the state recognition, the motion system, the HMI system, and the body system, respectively, and are functional units that integrate the ECUs belonging to the domains.

The state management section 108 is one of programs for controlling a control target. The state management section 108 calculates, for example, an operation amount of an actuator or a sensor that is a control target, and sends a command including the operation amount to the various control units 191 to 199. That is, the state management section 108 has a function of generating a second command embodying the first command when the abstracted first command is input. Note that the vehicle service section 107 may have a function of generating the second command embodying the first command.

The state management section 108 is also a program for sending data obtained from a sensor or an actuator to the service application 106. In other words, the state management section 108 realizes a function of “state recognition” and a function of “equipment control”. In the function of the state recognition, sensor data obtained from the equipment management section 109 (each of the control units 191 to 199 to be described later) or data obtained by converting an actuator into a format suitable for the vehicle service section 107 is transmitted to the vehicle service section 107. In the function of the equipment control, a drive instruction from the vehicle service section 107 is distributed to the equipment management section 109.

The state management section 108 may be installed in the same ECUA 110 as that of the vehicle API 171, or may be installed in the ECUC 120, the ECUD 125, or the ECUE 130, which is another ECU. The state recognition unit 181, the motion system equipment control unit 182, the HMI system state recognition unit 183, and the body system control unit 184, which are the state management section 108, may all be installed in the same ECUA 110 as that of the vehicle API 171. Alternatively, it may be distributed and installed in each ECU that controls each domain.

In the function of the state recognition, a function of classifying individual sensor raw data acquired by the equipment management section 109 from the vehicle sensor into data for each sensing target that is easy for the service application 106 to use is implemented. Furthermore, a function of integrating data, converting the data into information with a higher abstraction level, and transmitting the information to the vehicle service section 107.

For example, in the function of the state recognition, each of the control units 191 to 199 constituting the equipment management section 109 acquires pieces of information such as a vehicle speed of 0 km/h, a shift position P, and absence of a driver in the vehicle, and mainly focuses on that the vehicle is in a parked state on the basis of these pieces of information. This information is further transmitted to the service application 106 via the vehicle service section 107.

For example, in a case where the service application 106 makes a request for a car finder, the vehicle service section 107 may combine ack from a light and ack from a horn into one operation result and respond to the service application 106. Here, ack is a response to the control request of the light and the horn. Furthermore, the car finder is a function of an application that notifies the user of the position of the vehicle in a parking lot or the like in an easy-to-understand manner.

In the function of the equipment control, each of the control units 191 to 199 (for example, an engine, a steering, a shift, a door, a window, an air conditioner, or the like) in the optimal equipment management section 109 is selected in order to realize the vehicle operation request from the service application 106. Then, the format is converted into a format of data that can be received by each of the control units 191 to 199, and the data is distributed in consideration of the order of transmission of the data.

For example, when the vehicle operation request is to “accelerate the vehicle at 0.3 G while turning the vehicle to the left with a radius of 200 m”, “request for the engine to output 1000 Nm and request for the steering to output −0.1 rad” is output in the function of the equipment control.

Furthermore, for example, it is assumed that the vehicle operation request is “shift to a parking state”. In this case, in the function of the equipment control, a “request for setting a shift to p, a request for an air conditioner to be off, a request for a window to be fully closed, a request for a door to be locked when the request described above is completed and there is no occupant, and a request for transition to a parking state” are output.

The state management section 108 is divided into a plurality of programs for each type of vehicle operation corresponding to the type of first command. The type of vehicle operation includes, for example, a traveling system related to turning, running, and stopping of the vehicle, an HMI system related to information presentation to the user, a body system related to a state change of the body, and the like. As described above, in the state management section 108, management functions 81 to 84 are provided according to the type of the domain, and the programs of the management functions are stored in the memory 122 of the ECUC 120, the memory 127 of the ECUD 125, the memory 132 of the ECUE 130, which are domain control units, or the memory 112 of the ECUA 110, which is an integrated ECU.

In other words, the state management section 108 is classified not for each implementation means (for example, each of the control units 191 to 199 or the like) that is likely to depend on vehicle variation but for each vehicle operation that is likely to be requested by the service application 106.

The state recognition unit 181 acquires information from the camera control unit 191 and the millimeter wave control unit 192, converts the information into information regarding the positions of the vehicle and the pedestrian, and outputs the information to the vehicle service section 107.

The motion system equipment control unit 182 converts the operation request of the vehicle into control amounts of the brake control unit 193 and the steering control unit 194 and outputs the control amounts.

The HMI system state recognition unit 183 receives a command of a warning, determines whether to perform notification using the display control unit 195 and the sound control unit 196, and outputs the control amount.

For example, the body system control unit 184 receives a command related to the vehicle environment, determines which one of the light control unit 197, the HVAC control unit 198, the seat control unit 199, and the like is to be operated, converts the command into an appropriate command, and outputs the command.

(5f) The ECU 10 and cloud server 43 described in the present disclosure, and methods performed by the ECU 10 and cloud server 43 may be implemented by a dedicated computer provided by configuring a processor and a memory, which are programmed to execute one or a plurality of functions embodied by a computer program. Alternatively, the ECU 10 and cloud server 43 described in the present disclosure, and the methods performed by ECU 10 and cloud server 43 may be implemented by a dedicated computer provided by configuring a processor with one or more dedicated hardware logic circuits. Alternatively, the ECU 10 and cloud server 43 described in the present disclosure, and the methods performed by the ECU 10 and cloud server 43 may be implemented by one or more dedicated computers configured by a combination of a processor and a memory, which are programmed to execute one or more functions, and a processor configured by one or more hardware logic circuits. Furthermore, the computer program may be stored in a computer-readable non-transitory tangible recording medium as an instruction executed by the computer. The method for implementing the functions of the units included in the ECU 10 and the cloud server 43 does not necessarily include software, and all the functions may be implemented using one or a plurality of pieces of hardware.

(5g) A plurality of functions of one component in the above-described embodiment may be implemented by a plurality of components, or one function of one component may be implemented by a plurality of components. Furthermore, a plurality of functions of a plurality of components may be realized by one component, or one function realized by a plurality of components may be realized by one component. Furthermore, a part of the configuration of the above-described embodiment may be omitted. Furthermore, at least a part of the configuration of the above-described embodiment may be added to or replaced with the configuration of another embodiment described above.

(5h) In addition to the data provision system 1 described above, the present disclosure can be realized in various forms, for example, devices such as the ECU 10 and the cloud server 43 which are components of the data provision system 1, a program for causing a computer to function as each of the devices, a non-transitory tangible recording medium such as a semiconductor memory in which the program is recorded, and a data provision method.

What is claimed is:

1. A vehicle control system comprising:
a first vehicle control device that is configured to control a control target mounted on a vehicle; and
a second vehicle control device that includes at least one processor and a memory coupled to the at least one processor and is communicably connected to the first vehicle control device,
wherein
the first vehicle control device transmits data regarding the first vehicle control device,
the second vehicle control device includes
an input unit configured to acquire the data transmitted from the first vehicle control device,
a calculation unit configured to convert the data acquired by the input unit into standardization data in a predetermined format for each type of the data, and generate semantic data obtained by semanticizing at least one piece of the standardization data, and
an output unit configured to transmit second data based on the semantic data to an application, and
the data transmitted from the first vehicle control device is transmitted in one direction according to an order of the input unit, the calculation unit, and the output unit.

2. The vehicle control system according to claim 1, wherein
the calculation unit includes at least two or more layers of:
a first layer having a function of converting the data acquired by the input unit into the standardization data in a predetermined format for each type of the data;
a second layer having a function of converting the standardization data into definition data which is a predefined value;
a third layer having a function of generating first integration data which is data integrated in a domain by using the standardization data or the definition data; and
a fourth layer having a function of generating second integration data which is data integrated across domains by using the standardization data, the definition data, or the first integration data.

3. The vehicle control system according to claim 2, wherein
the first layer, the second layer, the third layer, and the fourth layer are hierarchized in an order of the first layer, the second layer, the third layer, and the fourth layer, and
data is transmitted and received in one direction according to the order of the layers.

4. The vehicle control system according to claim 1, wherein
the calculation unit includes:
a first calculation unit configured to convert the data acquired by the input unit into standardization data in a predetermined format for each type of the data;
a second calculation unit configured to convert the standardization data into definition data which is a predefined value;
a third calculation unit configured to generate first integration data which is data integrated in a domain by using the standardization data or the definition data; and
a fourth calculation unit configured to generate second integration data which is data integrated across domains by using the standardization data, the definition data, or the first integration data.

5. A non-transitory computer readable storage medium storing a data conversion program to convert vehicle data obtained from a provision source device in a vehicle into provision data suitable for an application, when executed by at least one processor, causing the at least one processor to provide:
a first processing unit that is configured to convert the vehicle data into first data in a predetermined format for each type of the vehicle data;
a second processing unit that is configured to generate second data obtained by semanticizing at least one piece of the first data; and
a provision unit that is configured to provide at least one of the first data or the second data to a memory or a provision destination device, which is determined in advance,
wherein
data is transmitted in one direction according to an order of the first processing unit, the second processing unit, and the provision unit.

6. The non-transitory computer readable storage medium storing the data conversion program according to claim 5, wherein
the data conversion program is dispersively disposed in the vehicle and a cloud server outside the vehicle.

7. The non-transitory computer readable storage medium storing the data conversion program according to claim 6, wherein
the provision unit sets whether to provide data according to a collection condition, which is determined in advance.

8. The non-transitory computer readable storage medium storing the data conversion program according to claim 6, wherein
the first processing unit is disposed in the vehicle, and the second processing unit is disposed in the cloud server.

9. The non-transitory computer readable storage medium storing the data conversion program according to claim 7, wherein
the first processing unit and the second processing unit are disposed in the vehicle, and
the provision unit is disposed in the cloud server.

10. The non-transitory computer readable storage medium storing the data conversion program according to claim 5, wherein
the first processing unit and the second processing unit are disposed in a cloud server.

11. A data provision system comprising:
a first control unit that is provided in a vehicle; and
a second control unit that is provided in a cloud server,
wherein
the first control unit or the second control unit provides
a first processing unit configured to convert vehicle data obtained from a provision source device in the vehicle into first data in a predetermined format for each type of the vehicle data,
a second processing unit configured to generate second data obtained by semanticizing at least one piece of the first data, and
a provision unit configured to provide at least one of the first data or the second data to a memory or a provision destination device, which is determined in advance, and
data is transmitted in one direction according to an order of the first processing unit, the second processing unit, and the provision unit.

12. A vehicle control device communicably connected to a plurality of other devices controlling control targets mounted on a vehicle, the vehicle control device comprising:
at least one processor; and
a memory coupled to the at least one processor and storing program instructions that, when executed by the at least one processor, cause the at least one processor to provide:
an input unit configured to acquire data regarding other devices, the data being transmitted from any of the plurality of other devices;
a calculation unit configured to convert the data acquired by the input unit into standardization data in a predetermined format for each type of the data, and generate semantic data obtained by semanticizing at least one piece of the standardization data; and
an output unit configured to transmit second data based on the semantic data to an application,
wherein
data is transmitted and received in one direction according to an order of the input unit, the calculation unit, and the output unit.

13. The vehicle control system according to claim 1, wherein
the control target mounted on a vehicle includes at least one of an engine, a brake, a motor, a light, a display device, an air conditioner, a seat, a horn, a power generator, a camera and a millimeter wave.

14. The vehicle control system according to claim 1, wherein
the first vehicle control device transmits a sensor output value or an actuator control setting value of the control target as the data regarding the first vehicle control device.

15. The vehicle control system according to claim 1, wherein
the semantic data generated by the calculation unit includes meaning without being compared with other data.

16. The vehicle control system according to claim 1, wherein
the first vehicle control device and the second vehicle control device both are provided on the vehicle.
